(19) United States
(12) Patent Application Publication
(10) Pub. No.: US 2003/0084977 A1
(43) Pub. Date: May 8, 2003

(54) Apparatus for the identification and maintenance of tyres and wheels with tyres

(76) Inventor: Tullio Gonzaga, Correggio (IT)

Correspondence Address: R. Neil Sudol, Coleman Sudol Sapone, P.C., 714 Colorado Avenue, Bridgeport, CT, 06605-1601, US

(21) Appl. No.: 09/988,635

(22) Filed: Nov. 20, 2001

(30) Foreign Application Priority Data
Nov. 20, 2000 (IT) VR2000A000115

(51) Int. Cl. B60C 15/02

(52) U.S. Cl. 152/381.5

(57) ABSTRACT

Equipment for the identification and maintenance of tyres and wheels with tyres, including a machine (10, 11, 12) for tyre maintenance work and comprising a tyre identification or recognition device (1) having a display device (1) for the displaying of information in the form of numbers and letters regarding an identified tyre (P).

### DESCRIPTION

1. Field of the Invention

The present invention relates to an equipment suitable for the identification and maintenance of tyres and vehicle wheels with tyres.

2. Background of the Invention

For some years the large tyre manufacturers have been putting on the market tyres with microchips or identification bar codes or other identification codes for the purposes of semi-automated warehouse stock management and shipping.

### SUMMARY OF THE INVENTION

The main object of the present invention is to provide equipment suitable for the identification and maintenance of tyres and wheels with tyres that is suitable for taking advantage of the presence of chips or identification codes in a tyre to provide the operator maintaining the tyres, typically at a tyre centre, with a whole range of information such as the year of manufacture of a tyre, the number of times it has been inflated, what loads the tyre has been subjected to, its ideal pressure and other information and technical features regarding the tyre so as to put the operator in a position to make informed decisions when carrying out his maintenance work on the tyre, or in making the choice to replace the tyre.

Another object of the present invention is to provide an apparatus or equipment for the maintenance of tyres and wheels with tyres that has a tyre identification device that is easy to use even by operators that are not specially trained.

These and other objects that shall better appear below are attained by an equipment according to the present invention for the identification and maintenance of tyres and wheels with tyres, which equipment comprises a tyre maintenance machine and is characterised in that it comprises a tyre identification or recognition device having a display for displaying numbers and letters information about a tyre being identified.

Advantageously, the said identification device comprises at least one code detector, a data memory for the codes and data on predetermined tyre types, at least one comparator circuit arranged to compare a code that has been read by said code reading device with the codes in the said memory and at least one display device connected to said comparator device(s).

### BRIEF DESCRIPTION OF THE DRAWINGS

Further aspects and advantages of the present invention will better appear from the following detailed description of some embodiments thereof given merely by way of non-limiting examples, with reference to the accompanying drawings, in which:

FIG. 1 is a block diagram illustrating a recognition or identification device for a tyre according to the present invention;

FIG. 2 is a schematic elevation side view of a tyre mounting and dismounting machine fitted with a tyre identification device of FIG. 1;

FIG. 3 is a schematic elevation side view of an inflation cage fitted with a tyre identification device of FIG. 1; and

FIG. 4 is a schematic elevation side view of a wheel balancing machine fitted with a tyre identification device of FIG. 1.

In the accompanying drawings parts or components that are the same or similar have been given the same reference numerals.

### DESCRIPTION OF THE PREFERRED EMBODIMENTS

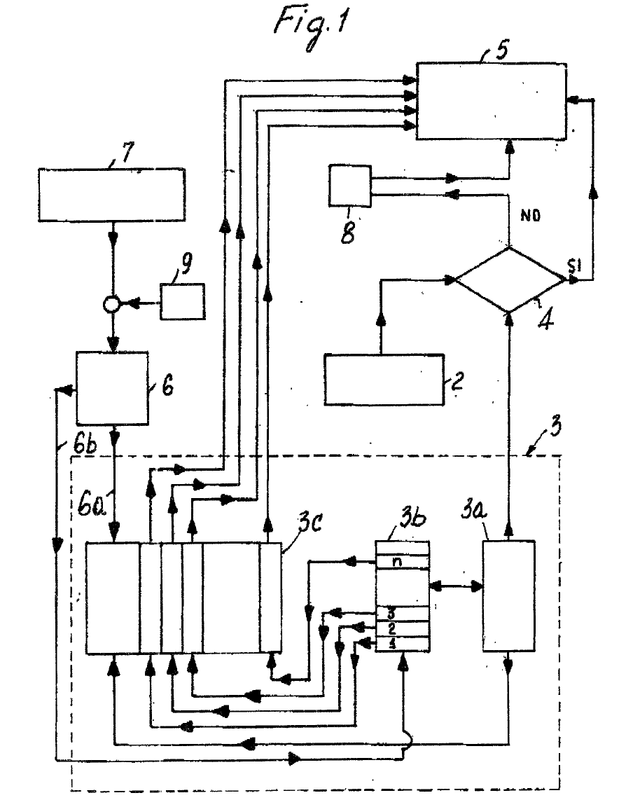

With reference to the above-listed Figures, it will be noted that an identification device 1 for a tyre P substantially comprises a detector 2, e.g. a code reader of any suitable kind, and a minicomputer comprising a memory 3 (in a doted rectangle in FIG. 1), a comparator 4, a display 5 (typically a monitor of any suitable type), a decoder 6 and an access keyboard 7. The memory 3 comprises a portion 3a designed to store a predetermined number of codes, a portion 3b suitable for storing a pre-established number of characters from 1 to n and a portion 3c arranged to perform the functions of character recognition of those characters in the portion 3b to display them, if required, on the display 5 and of generating new characters to form and/or display new codes on the monitor 5.

The detection device 2 is designed to detect or read the identification code of a tyre P, which code is compared in the comparator 4 with the codes stored in the area 3a of the memory. If the code that is read or detected in other ways is found to correspond to a code stored in the memory it will be displayed on the display 5.

Should the code detected by the detector 2 not coincide with a code already stored in memory, a discriminator 8 that is designed to establish whether it is a code that really exists but is not stored in memory, in which case, if desired, the code read is displayed on the display 5 or whether it is an absence of code on the tyre P, in which case the wording “no code” or such like would be displayed to bring the operator's attention to this fact.

If it is desired to enter a new code or other information in memory 3, keyboard 7 is used which through the decoder 6 and line 6a detects whether the data already exist in memory, data that, if it is so wished, can be displayed on the monitor 5, whereas through a line 6b it stores new numerical and alphabetic data in the memory 3.

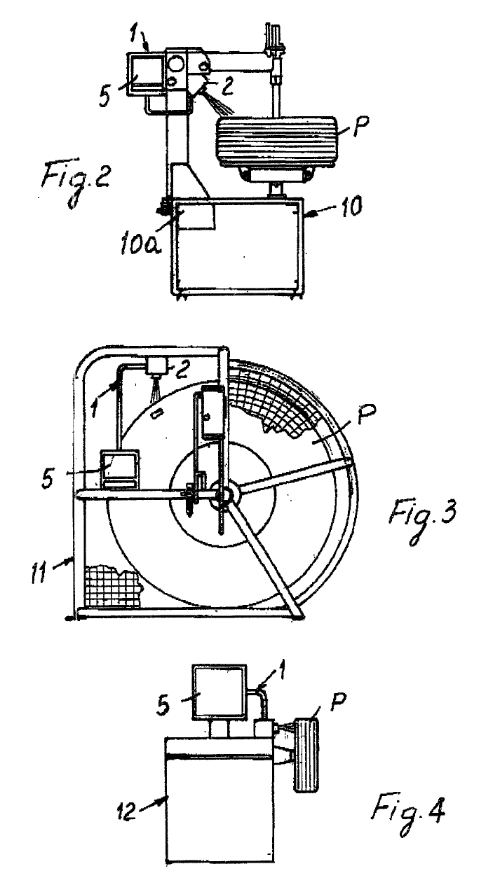

As is schematically illustrated in the FIGS. 2 to 4, the device 1 can be easily and advantageously installed on a tyre mounting and dismounting machine 10 (FIG. 2), an inflation cage (FIG. 3) and/or a wheel balancing machine 12 (FIG. 4) for wheels with tyres so that the operator can be informed on site and in real time of the actual construction characteristic features of the tyre as well as any “history” regarding the tyre P that is being worked on (such as its date of manufacture, the date it was mounted on the wheel, the number of times it has already been inflated, the ideal or recommended inflating pressure, the type of material that would be most suitable if it were necessary to repair the tyre, any repair procedures to be followed, and so forth).

This is not, however, all. As a tyre worker will be aware, when tyre manufacturers decide to put a new type of tyre onto the market, if the tyre centres have equipment 10, 11, 12 with a device according to the present invention, they need no longer incur delay costs due to the need to inform and properly train tyre workers (tyremen) far in advance as it is enough just to update the various machines throughout the geographical area, e.g. by means of Internet through a suitable web connection 9, entering in memories 3 and providing new data and instructions relating to the new type of tyre for prompt and effective updating for the operators engaged in tyre maintenance work.

It will be noted that with equipment designed according to the present invention it is possible:

to carry out updates of the data in memory on the one hand by means of the keyboard 7 in the form of the manual entering of new codes or by the addition of data in memory 3 after maintenance work has been carried out on a determined tyre so checks can then be carried out by a chip inserted into the tyre to update the tyre after maintenance work has been carried out on that tyre and, on the other hand, by connecting the maintenance machines to the network for updating machines scattered over large areas about new types of tyres, instructions for their use and so forth;

for the equipment to act as an active guide for a tyre mounting and dismounting machine where it is suitably fitted with mounting and dismounting stress sensors, e.g. a sensor 10a (FIG. 2) that monitors electrical current absorption, in the case of an electric motor, or the pressure of the air supplied, in the case of a pneumatic motor, thus running a control on the degree of stresses to which the tyre is subjected during the maintenance operations;

for automatically driving the equipment, e.g. a tyre mounting and dismounting machine by having the machine carry out all or some of the tyre mounting and/or dismounting operations in an automated manner or through the use of robots.

The above described invention is susceptible to numerous modifications and variations within the scope of the claims.

1. Equipment for the identification and maintenance of tyres and wheels with tyres including a machine for tyre maintenance work and being characterized in that it comprises a tyre identification or recognition device having a display device for the displaying of information in the form of numbers and letters regarding an identified tyre.

2. Equipment according to claim 1, wherein said identification device comprises at least one code detector, at least one data memory regarding the codes and data on predetermined types of tyres, at least one comparator circuit suitable for comparing a code that is detected by said code detector with the codes stored in said memory, at least one display device connected to each comparator circuit.

3. Equipment according to claim 1, wherein said identification device comprises at least one access means to said memory or memories, a decoder means between the or each access means and the said memory or memories for the storing data and codes in said memory or memories and their being displayed on said display device.

4. Equipment according to claim 3, comprising a discriminator means between an output of said comparator device and said display device.

5. Equipment according to any claim 1, comprising a tyre mounting and dismounting machine.

6. Equipment according to claim 5, wherein said tyre mounting and dismounting machine comprises at least one stress detector to detect stress exerted on a tyre.

7. Equipment according to any claim 1, comprising a wheel balancing machine.

8. Equipment according to any claim 1, comprising an inflating station.
